(19) United States
(12) Patent Application Publication
(10) Pub. No.: US 2007/0094122 A1
(43) Pub. Date: Apr. 26, 2007

(54) Method and apparatus for dynamic pricing exchange

(75) Inventor: Brian Dillon-Ferris, London (GB)

Correspondence Address: HEIMLICH LAW, 5952 DIAL WAY, SAN JOSE, CA, 95129, US

(73) Assignee: DEALMAKER.COM LTD, Leatherhead (GB)

(21) Appl. No.: 10/561,899

(22) PCT Filed: Feb. 8, 2004
(86) PCT No.: PCT/EP04/50094

§ 371 Date: Dec. 22, 2005

Related U.S. Application Data
(60) Provisional application No. 60/480,544, filed on Jun. 23, 2003.

(51) Int. Cl. G06Q 40/00

(52) U.S. Cl. 705/37

(57) ABSTRACT

A method and apparatus for dynamic pricing exchange have been disclosed.

### RELATED APPLICATIONS

This patent application claims priority of U.S. Provisional Application Ser. No. 60/480,544 filed Jun. 23, 2003 titled “Electro-Dynamic Pricing Exchange”, which is hereby incorporated herein by reference. This patent application claims priority of PCT Application Serial No. PCT/EP2004/050094 filed on Feb. 8, 2004, titled “Electro-Dynamic Pricing Exchange”, which is by the same inventor as this application and which is hereby incorporated herein by reference.

### FIELD OF THE INVENTION

The present invention pertains to pricing systems. More particularly, the present invention relates to a method and apparatus for dynamic pricing exchange.

### BACKGROUND OF THE INVENTION

In commerce, pricing is generally considered to be one of the most critical elements in any commercial enterprise. It is also often the most difficult to optimize. Economists know that setting fixed prices may hinder sales, since some customers may be seeking lower prices while others may be willing to pay more than the asking price. As a result, fixed pricing runs the risk of either leaving money on the table and/or ending up with unsold inventory. This may present a problem.

Dynamic pricing is an alternative to fixed pricing and occurs when prices are free to respond to changes, for example, in supply and demand. Two examples of dynamic pricing systems are Internet auctions and electronic stock exchanges. On-line auctions facilitate sales of basic commodities, such as personal property, used cars, computers, or surplus inventory liquidations, etc. Electronic stock exchanges facilitate the sales of base commodities such as gold, silver, financial instruments such as corporate shares and derivatives, etc. These examples are considered to be basic because of the absence of any complex variable elements. That is, they are “fixed” to the extent that the offerings are fixed and do not change. On the other hand, a product having a variety of user defined options, such as new vehicles and new computers with a variety of options available and selectable by the user, are examples of complex multi variable commodities. Pricing such a product may present a problem.

### BRIEF DESCRIPTION OF THE DRAWINGS

The invention is illustrated by way of example and not limitation in the figures of the accompanying drawings in which:

FIG. 1 illustrates a network environment in which the method and apparatus of the invention may be used;

FIG. 2 is a block diagram of a computer system in which some embodiments of the invention may be used;

FIG. 3 illustrates one embodiment of the invention showing a general overview of a sales listing procedure and a sequence of events;

FIG. 4 illustrates one embodiment of the invention showing a tabular view of a new order showing a variable configuration;

FIG. 5 illustrates one embodiment of the invention showing a variable and dynamic product configuration screen;

FIG. 6 illustrates one embodiment of the invention showing a dynamic order book viewer screen;

FIG. 7 illustrates one embodiment of the invention showing a screen having variable features available for a single new automobile; and

FIG. 8 illustrates one embodiment of the invention in flowchart form.

### DETAILED DESCRIPTION

The invention, as exemplified in various embodiments, illustrates dynamic pricing. In one embodiment of the invention, the dynamic pricing is used as an exchange. In one embodiment of the invention, it is capable of coordinating multi-variable order (re)configurations and a dynamic pricing system. In one embodiment of the invention a practical method for different traders or bidders to select or deselect their own unique set of model variations and optional equipment ‘on-the-fly’ while competing in the same bidding process is possible. In one embodiment of the invention negotiating prices of complex multi-variable commodities, such as, for example, new vehicles or new computers, is possible.

The present invention (also referred to as dynamic pricing exchange or “DPX”) in one embodiment can manage “real-time” dynamic pricing transactions of multiple item complex orders for new vehicles and new computers, and can be applied to anything with multi-variable characteristics. Such products are offered for sale with a variety of optional features, selectable by the purchaser. For example, a vehicle may have as many as a hundred variable features. Thus, a wholesale order for 10 vehicles could contain over a thousand variables which all need be resolved during the sales process. Selecting or deselecting such a vast number of variables during a live unmanned electronic bidding process is possible in one embodiment of the present invention. The present invention in one embodiment also contains a variable product option selector apparatus capable of handing any number of options, and a pricing synchronizer.

In one embodiment the invention allows buyers and sellers of new vehicles, new computers, or anything else with multiple choice features to select or deselect any possible options, completely ‘on-the-fly’ and trade instantly at the current market prices, or to modify the order and by so doing submit a new order which is then posted to a perpetual bid/offer matching engine. The order may be matched instantaneously or it may be reviewed and accepted by any other registered trader. Orders may be continuously ranked in order of priority sequence selected by the client viewer. One of the commercial advantages of such a system is that it has the ability to create growth in user numbers because each respondent must register as a client to answer or counter-bid any offer received.

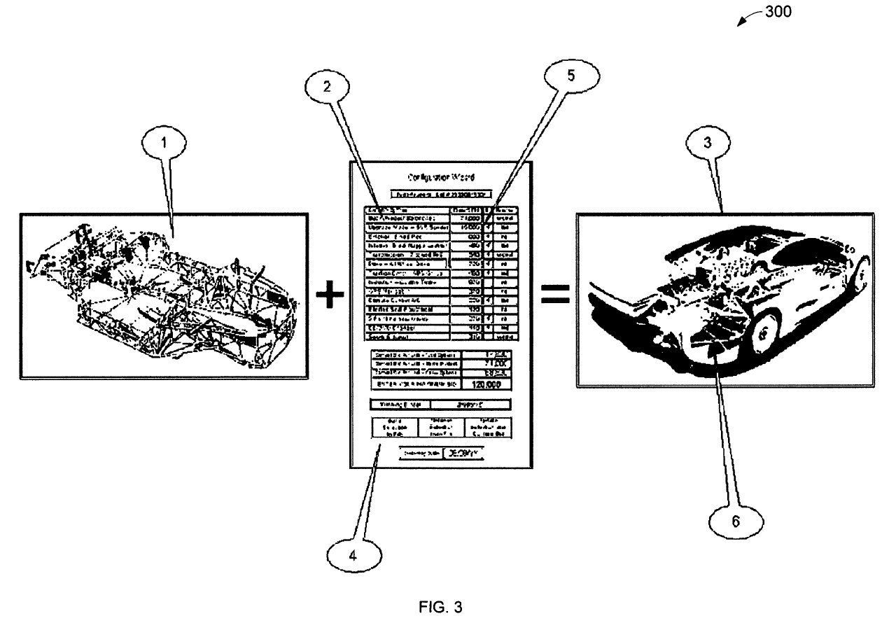

FIG. 3 illustrates at 300 one embodiment of the invention showing a general overview of a sales listing procedure and a sequence of events. At 1 is shown a listing of the basic versions of the products available, with no optional features included. At 2 is a full list of all optional equipment, recommended prices, and estimated delivery dates for all available options. At 3 are representations of the product, for example, digital photographs can also be included, showing how the products would appear after each model variation or visible feature has been added, including different viewing angles. At 4 a seller can also provide all their product costing information so that the system can monitor every transaction to calculate instant profit and loss figures for automated negotiation protocols. At this point the product is basically ready for trading. At 5 a trader may then select any components, variations and quantities required. At 6 the product image may change to reflect each trader's unique selection of colors and optional features. Depending on the product, different angles and multimedia presentations may also be available for viewing.

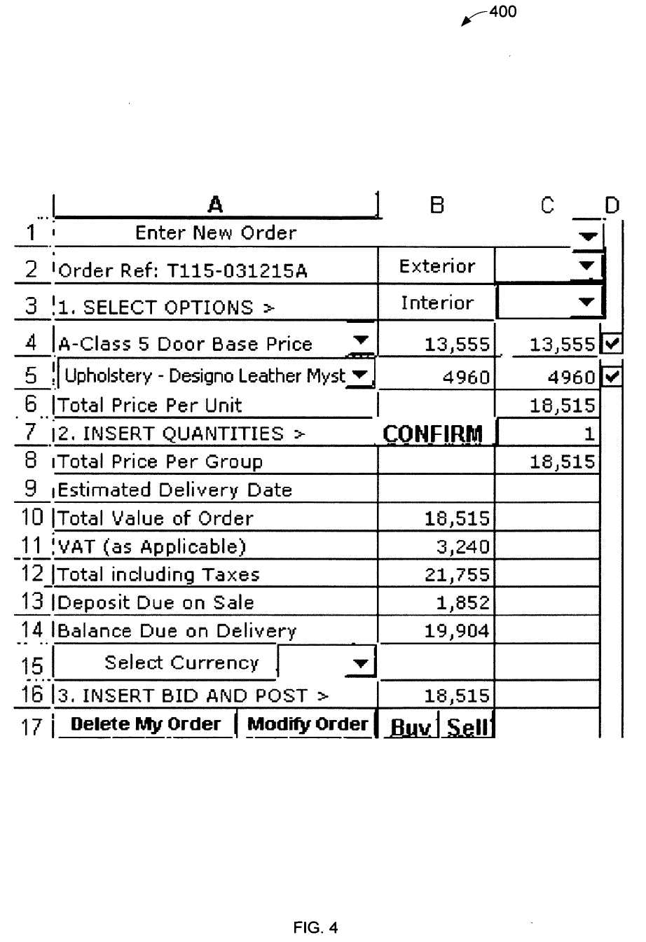

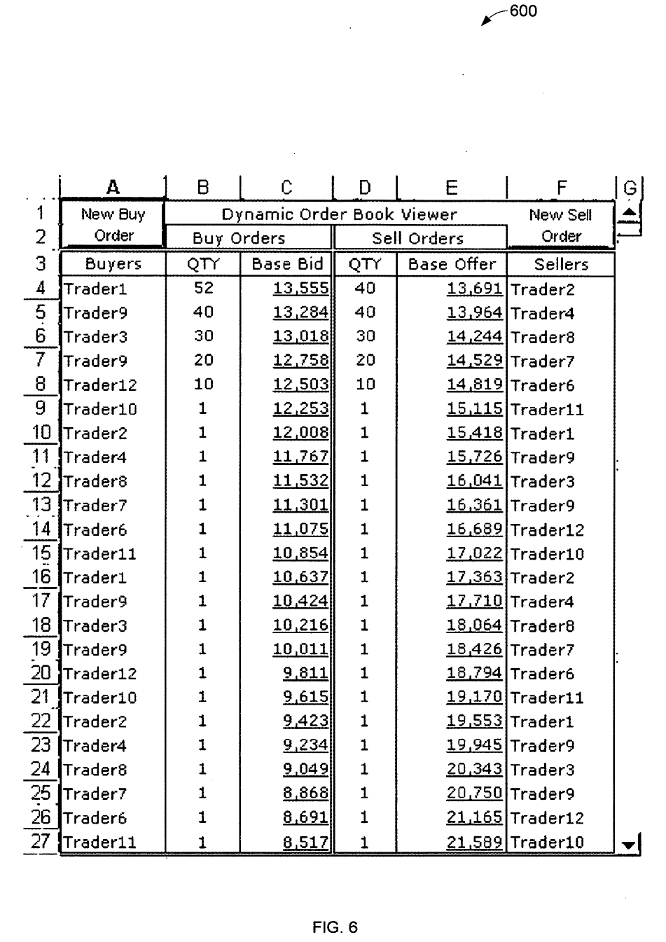

FIG. 4 illustrates at 400 one embodiment of the invention showing a tabular view of a new order showing a variable configuration. In FIG. 4 the number of columns and rows are infinitely expandable from the standpoint of being able to handle any number of options, choices, etc. For the purpose of explanation each column is labeled with letters of the alphabet (here A, B, C, and D) and each row is labeled numerically (here 1 through 17). The cells are referred to by their intersect label. For example; the cell at the intersection of column 2 and line 3 would be identified as B3. This example order screen shows a new vehicle transaction. It shows an order for just one base vehicle shown on line 4 and one additional option selected on line 5. (See the check boxes ticked in column D.) As each component is added from the new pull down menu created in column “A” an additional row is automatically added, ready for the next item selection, and so on, until all required components have been added. Different product specifications are grouped in separate columns to maintain detail order integrity. In this example only one column (C) has been activated. Starting prices are automatically posted (from, for example, a system database) with the manufacturer's recommended selling prices (MSRP). After configuring the order by selecting items from the pull down menus and ticking the applicable columns the trader may then enter the quantity (C7), enter their bid or offer (B16), and click buy or sell (B17) to post the order to the perpetual bid/offer matching engine and a dynamic order book viewer (such as that shown in FIG. 6).

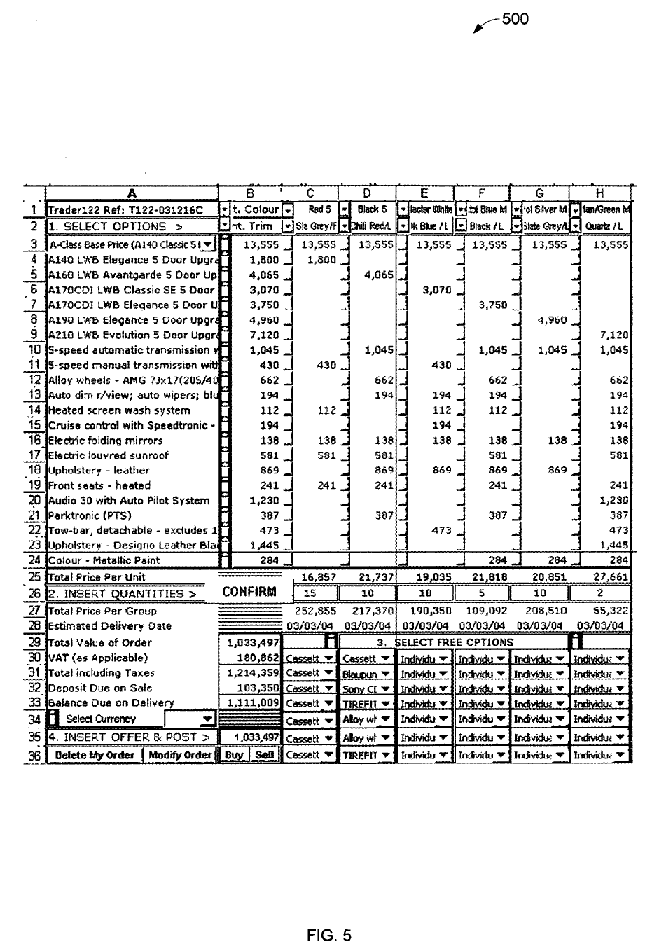

FIG. 5 illustrates one embodiment of the invention 500 showing a variable and dynamic product configuration screen. The table depicts a more complex order than that shown in FIG. 4. Many optional features are selected (A4:A24) and numerous product column groups have been created (C:H). Each order has a unique tracking code (A1). Item description fields also contain “info” links to full detail specifications and pictures of items selected. Cell B4 through B24 show the current prices for all items shown in rows A3:A24. Column and rows shown from C4 through H24 represent selection boxes for adding or deleting optional items to each column group. Row 25 shows the total calculated unit price for each column group. A trader enters the required quantities for each product group on row 26. Row 27 shows the calculated total for each column selection. Cell B29 shows the total net order value. Cell B30 automatically shows any taxes payable according to the status of the bidder. Cell B31 shows the total including any taxes. Cell B32 shows the deposit due on sale according to trader status. Cell B33 shows the total balance payable upon delivery. Row 28 shows the estimated availability date for delivery of the product according to the selection of features matched against the suppliers' current delivery schedule for the slowest item selected. This cell is continuously updated whenever a column selection changes or the supplier updates the database delivery schedule. Cell A34 contains a pull down menu for the bidder to select the display currency of their choice. Cell B35 is the main bid/offer input field. After the amount is entered the trader clicks the buy or sell button (B36) to confirm and post the order to the perpetual bid/offer matching engine and order book viewer.

Note that in one embodiment of the invention, when the bid amount is edited, for example in cell B35, every price in the entire component catalog changes in unison at precisely the same rate of change. This applies to all items available to client(s), whether actually selected by the trader or not. This technique allows infinitely variable product reconfiguration “on-the-fly” at any time during a competitive dynamic commerce transaction, by always maintaining integrity of pricing ratios throughout the entire order. This is especially important for dynamic pricing systems, such as on-line auctions or other dynamic pricing exchanges.

FIG. 6 illustrates one embodiment of the invention 600 showing a dynamic order book viewer screen. The order book viewer screen shows the output of a Perpetual Bid/Offer Matching Engine in a dynamic ranking order book viewer. Whenever new orders are posted they appear on this viewing system in ascending or descending order according to user settings for any column. Traders can see a general description of any order simply by hovering a mouse pointer over the bid/offer price. Any order can be clicked open, modified and reposted as a new order, deleted (by the owner), or accepted by any registered trader. The matching engine searches continuously for exact or closely matching buy/sell orders and alerts traders using pre-arranged contact methods.

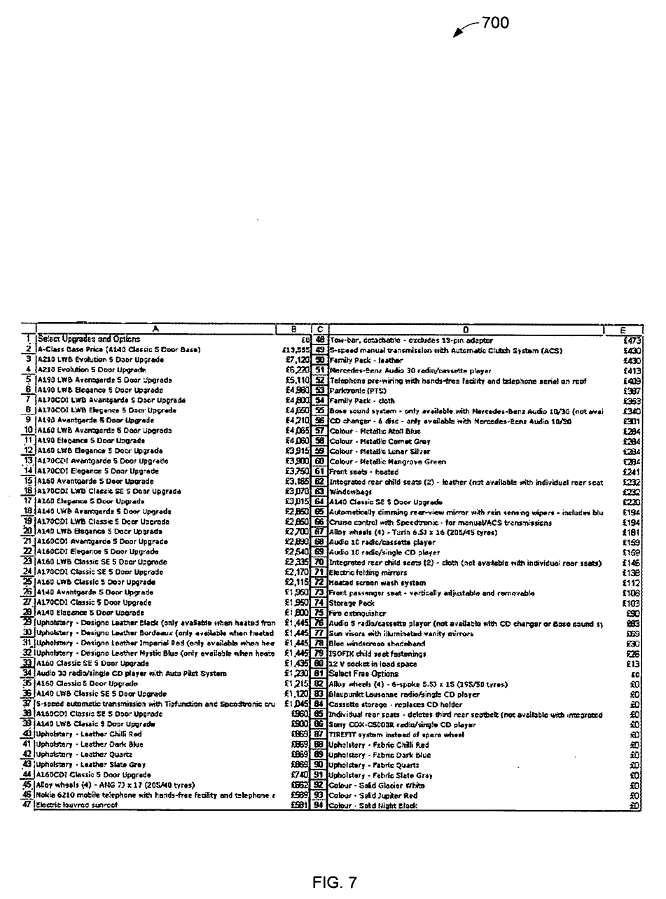

FIG. 7 illustrates one embodiment of the invention 700 showing a screen having variable features available for a one single new automobile. In this example over 90 different variables are be resolved during the sales process for each such vehicle. All chargeable items are re-priced in equal ratio to each other every time a bid or offer changes during an auction or the dynamic pricing process. This may happen many times a minute.

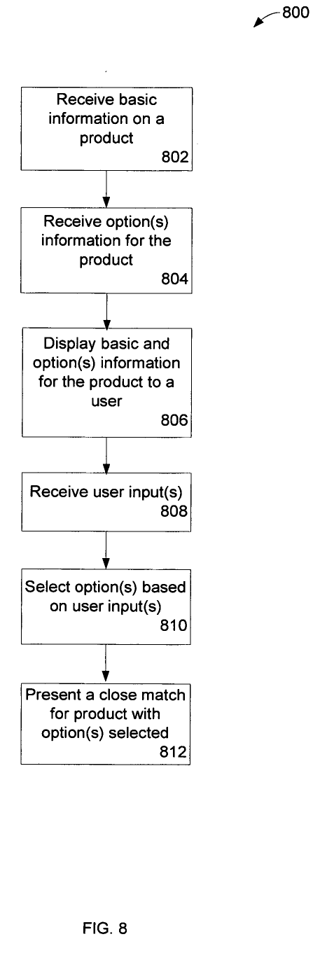

FIG. 8 illustrates one embodiment of the invention 800 in flowchart form. At 802 basic information on a product is received. At 804 information on options for the product is received. At 806 the basic and options information for the product is displayed to a user. At 808 user inputs are received and at 810 options for the product are selected based on the user inputs received at 808. At 812 a close match for the product with the selected options is presented to the user.

While the present invention has been described with respect to the Internet, auctions, and pricing the invention is not so limited. The techniques described may be used for any application where dynamic “matching” is needed. For example, any application where the management of dynamic product variables “on-the-fly” is required. The techniques disclosed may be used to match supply to demand, shipments to shippers, passengers to airline seats, etc.

As discussed, embodiments of the invention may use an infinitely expandable product order configuration where interactive columns are automatically added to allow multiple groups of dissimilar products to be ordered simultaneously. An infinite number of rows can also be added automatically after each of any number of available component options are selected from pull-down menus. The dynamic pricing system can recalculate the prices of each and every item on any size order, completely in unison and using equal ratios to each other, in response to an input by client to any entry field, such as, but not limited to, the total bid, offer price, etc. It will also recalculate the entire order automatically when the order is changed in any way.

As discussed a perpetual bid/offer matching engine (i.e. constantly matching) and electronic order book system receives all posted orders. It then ranks and displays the orders in any sequence selected by the client. The system can match buy/sell orders automatically or alert traders to the closest matches. The viewer can also see the general contents of any order in a pop-up bubble simply by hovering a mouse pointer over any price. The client can select any order from the electronic order book to open it in full detail view. The client can then either accept the order by confirming a purchase or sale, or they could modify the order, thus creating another new order and post it to the order book. Traders can also delete their own orders any time before acceptance by another trader.

In one embodiment the invention provides a fully integrated and insured escrow service for every transaction, thus eliminating the risk of fraud or non payment of debts. Prior to placing a bid buyers must first authorize an electronic funds transfer or EFT payment into their escrow deposit account equal to a pre-determined percentage of estimated trading requirements. After an order is accepted the required down-payment is automatically transferred from the buyer's deposit account to the escrow transaction account. Closing instructions are then drawn and confirmed. Payments are held in neutral escrow pending completion of both buyer's and seller's obligations, then transferred to the seller's account.

In one embodiment the invention facilitates the trading of “Call” or “Put” Options on applicable commodities. Approved buyers may convert their down-payment into an option-premium payment. The option-holder may then have an extended period of time to either exercise the option, pay and take delivery of goods, with credit for any remaining value of option premium, or sell and/or assign the option to anyone else, or even allow the option to expire, without any further obligations.

Thus a method and apparatus for dynamic pricing exchange have been described.

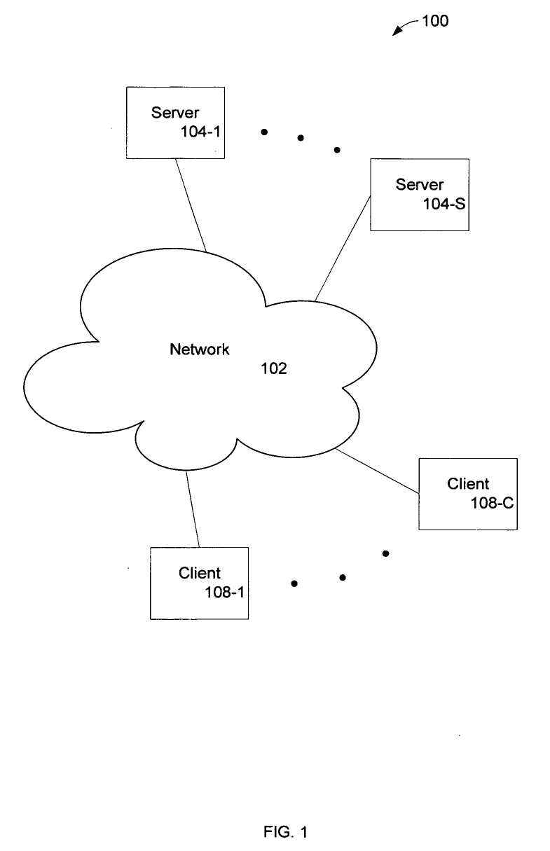

FIG. 1 illustrates a network environment 100 in which the techniques described may be applied. The network environment 100 has a network 102 that connects S servers 104-1 through 104-S, and C clients 108-1 through 108-C. More details are described below.

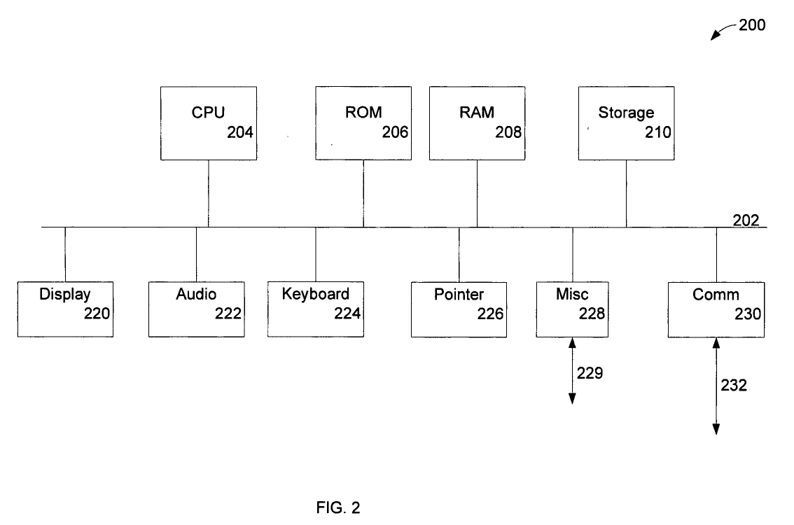

FIG. 2 is a block diagram of a computer system 200 in which some embodiments of the invention may be used and which may be representative of use in any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210, may be Compact Disc (CD), Digital Versatile Disk (DVD), hard disks (HD), optical disks, tape, flash, memory sticks, video recorders, etc. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of skill in the art that the present invention may be practiced without these specific details. In some instances, well-known structures and devices are shown in block diagram form, rather than in detail, in order to avoid obscuring the present invention. These embodiments are described in sufficient detail to enable those of skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of skill in the data processing arts to most effectively convey the substance of their work to others of skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities.

Further, any of the methods according to the present invention can be implemented in hard-wired circuitry, by programmable logic, or by any combination of hardware and software.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software.

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

As used in this description, the term “escrow” or similar terms is defined as any transaction wherein one person, for the purpose of effecting the sale, transfer, encumbering, or leasing of any property to another person, delivers any written instrument, money, evidence of title to real or personal property, or other thing of value to a third person to be held by such third person until the happening of a specified event or the performance of a prescribed condition, when it is then to be delivered by such third person to a grantee, grantor, promisee, promisor, obligee, obligor, bailee, bailor, or any agent or employee of any of the latter.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for dynamic pricing exchange have been described.

What is claimed is:

1. A method comprising:
receiving basic information for a product;
receiving option information for said product;
displaying said basic information and said option information to a user;
receiving one or more user inputs;
selecting one or more options based on said received one or more user inputs; and
presenting a substantially close match for said product with said selected options.

2. The method of claim 1 wherein said one or more user inputs are received from a plurality of users.

3. The method of claim 2 wherein one or more of said one or more user inputs consists of information selected from the group consisting of a buying price range, a selling price range, a bid price, a strike price, a selling price, a reserve price, and a selling price.

4. The method of claim 2 wherein said match is a price.

5. The method of claim 2 further comprising displaying said product with said selected one or more options.

6. The method of claim 2 wherein said selecting further comprises deselecting a previously selected one or more options.

7. The method of claim 6 further comprising a user input form which automatically expands in response to items added and contracts in response to items deleted.

8. The method of claim 7 wherein said expansion and contraction is in a direction selected from the group consisting of horizontally and vertically.

9. The method of claim 2 further comprising updating all prices associated with said product and all options regardless of said selected options.

10. The method of claim 9 wherein said updating occurs in response to said one or more user inputs.

11. The method of claim 10 wherein said presenting further comprises a viewing screen dynamically changing in response to inputs selected from the group consisting of new inputs from users, new inputs from sellers, accepted bids, rejected bids, modified listings, removed listings, delivery dates, changes in delivery dates, user sorting preferences, and user searching.

12. The method of claim 2 wherein said displaying further comprises:
setting a base starting price for said user; and
displaying to a seller updated profit/loss relative to a current bid from said user.

13. A machine-readable medium having stored thereon instructions, which when executed performs the method of claim 1.

14. A system comprising a processor coupled to a memory, which when executing a set of instructions performs the method of claim 1.

15. A method comprising starting an auction which is to end after a predetermined time interval based on an event selected from the group consisting of receipt of a first bid, receipt of a second bid, and receipt of a rival bid.

16. The method of claim 15 wherein said predetermined time interval may be extended or reduced by a time period based on bidding activity resulting in an actual auction closing time.

17. The method of claim 16 wherein said actual auction closing time is only visible during said extended/reduced time period and only to one bidder, said one bidder being in a leading position at any moment in said extended/reduced time period.

18. The method of claim 16 further comprising selecting a bid fixed at a prorated percentage premium above a current highest bid and resulting in said actual auction closing time.

19. An apparatus comprising:
means for receiving basic information for one or more products;
means for receiving option information for said one or more products;
means for displaying said basic information and said option information to one or more users;
means for receiving inputs from said one or more users;
means for selecting one or more options based on said received inputs from said one or more users; and
means for presenting one or more listings for said product with said selected options to said one or more users.

20. A machine-readable medium having stored thereon information representing the apparatus of claim 19.
